(19) United States
(12) Patent Application Publication
(10) Pub. No.: US 2026/0318103 A1
(43) Pub. Date: Oct. 15, 2026

(54) SYSTEM AND METHOD FOR SECURING A POST TO A MOUNTING SURFACE

(71) Applicant: Parasoleil, LLC, Westminster, CO (US)

(72) Inventor: Michael E. Schock, Arvada, CO (US)

(21) Appl. No.: 19/645,553

(22) Filed: Apr. 13, 2026

Related U.S. Application Data
(60) Provisional application No. 63/787,509, filed on Apr. 11, 2025.

(51) Int. Cl. E04H 12/22; F16B 9/02

(52) U.S. Cl. CPC E04H 12/2261; F16B 9/02

(57) ABSTRACT

Systems and methods for securing a post to a mounting surface include an elongated post having opposite end portions. A base plate is provided, having opposite surfaces, and a perimeter that is larger than a periphery of a cross-sectional shape of the elongated post. A spacer plate is provided, having a spacer plate thickness and a central aperture. An upper surface of the spacer plate is positioned closely adjacent a lower surface of the base plate. Fasteners are provided, having head portions and opposite, distal end portions. The distal end portions of the fasteners are disposed through the base plate and secured with an end portion of the elongated post so that the head portions of the fasteners are disposed within the central aperture of the spacer plate and positioned closely adjacent a lower surface of the base plate.

### CROSS-REFERENCE TO RELATED APPLICATIONS

The present application is a non-provisional of United States Provisional Patent Application Ser. No. 63/787,509, titled “System and Method for Securing a Post to a Mounting Surface”, filed Apr. 11, 2025, which is incorporated herein as if set out in full.

### BACKGROUND

Posts can be secured with a mounting surface and then provide support to a multitude of different structures. Fences, railings, screen systems, shade systems, and guardrails all use posts that must be secured with a mounting surface, such as concrete. There are many different systems and methods for securing posts to mounting surfaces. However, many such systems and methods provide results that are less than satisfactory. For example, several known systems and methods are not rated for high wind loads, which are experienced in various geographic locations. Inferior mounting systems and methods can also limit the post height that can be used. For example, some systems and methods only allow for the use of posts having a maximum height of only 72 inches, whereas some applications call for posts that are significantly taller.

Some attempts to make posts more robust have increased post mounting strength. However, these systems and methods have made the systems and methods more complex and sacrificed the desired appearance. This raises manufacturing and assembly costs and leaves unsightly posts that require additional exterior fasteners, brackets, and other support structures.

Accordingly, there is a need to provide a system and method by which posts can be secured to generally horizontal mounting surfaces in such a way as to meet or exceed the functional requirements of structural rigidity and strength. At the same time, such systems and methods need to address aesthetic concerns surrounding the visibility and unsightly nature of the anchoring device and the fasteners used therein.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In one aspect of the present technology, a system for securing a post to a mounting surface includes an elongated post having a first end portion, an opposite, second end portion, and a cross-sectional shape having a periphery. The system further includes a base plate, having an upper surface, an opposite lower surface, and a perimeter that is larger than the periphery of the cross-sectional shape of the elongated post. A spacer plate, having an upper surface, and an opposite, lower surface that define a spacer plate thickness is provided, wherein the spacer plate includes a central aperture that extends through the upper surface and lower surface. The upper surface of the spacer plate is positioned closely adjacent the lower surface of the base plate. A plurality of fasteners, having head portions and opposite, distal end portions are provided, wherein the distal end portions of the fasteners are disposed through the baseplate and secured with the first end portion of the elongated post, so that the head portions of the fasteners are disposed within the central aperture of the spacer plate and positioned closely adjacent the lower surface of the base plate.

In another aspect of the present technology, a method for securing a post to a mounting surface includes securing a first end portion of an elongated post with a base plate using a plurality of fasteners having head portions and opposite, distal end portions. The base plate has an upper surface, an opposite lower surface, and a perimeter that is larger than a periphery of a cross-sectional shape of the elongated post. The method further includes positioning an upper surface of a spacer plate closely adjacent the lower surface of the mounting plate. The upper surface of the spacer plate and an opposite lower surface of the spacer plate define a spacer plate thickness. The spacer plate includes a central aperture that extends through the upper surface and lower surface. The distal end portions of the fasteners are disposed through the baseplate and secured with the first end portion of the elongated post so that the head portions of the fasteners are disposed within the central aperture of the spacer plate and positioned closely adjacent the lower surface of the base plate. The method also includes positioning the lower surface of the spacer plate closely adjacent the mounting surface. The method further includes securing the spacer plate and base plate with the mounting surface using a plurality of mounting fasteners.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts an exploded, isometric view of one embodiment of a post and base system of the present technology.

FIG. 2 depicts an assembled, lower isometric view of the post and base system of FIG. 1.

FIG. 3 depicts an assembled, upper isometric view of the post and base system of FIG. 1.

FIG. 4 depicts an upper isometric view of one embodiment of a post and removable top cap of the present technology.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

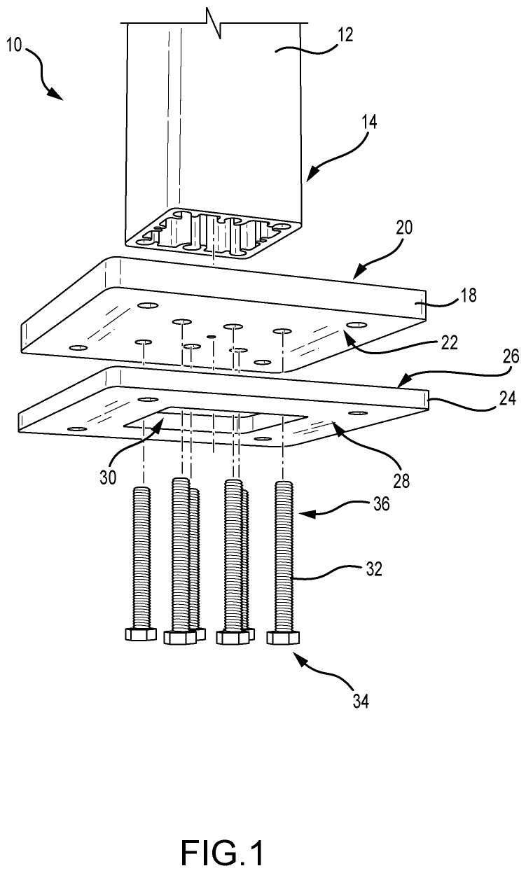

With reference to FIGS. 1-4, systems and methods of securing posts to mounting surfaces are provided. Such systems and methods are not limited in their application and can be used for a wide array of structures, including but not limited to fences, railings, screen systems, shade systems, and guardrails. In various embodiments, the design consists of an extruded aluminum, elongated post that includes six screw ports that are threaded to accept six 0.5-inch diameter hex bolts that mechanically fasten an aluminum base plate to the lower end portion of the post extrusion. The design also includes a 0.75-inch-thick polymer-based spacer plate, installed under the aluminum base plate, that creates the necessary space for the hex heads of the bolts between base plate and concrete mounting surface. Embodiments of the present technology can use posts that are at least 120 inches tall and rated for up to 140 mph wind loads, which is unmatched by any other known systems and methods of this type (post with mechanically fastened base plate).

With reference to FIG. 1, a system 10 for securing a post to a mounting surface is depicted in a disassembled state. In various embodiments, the system includes an elongated post 12 having a first end portion 14, an opposite, second end portion 16, and a cross-sectional shape having a periphery. In some embodiments, the elongated post 12 is formed from extruded aluminum, although other known materials may be used without departing from the scope of the present technology. Forming the elongated post 12 from extruded aluminum provides system 10 with a light weight without sacrificing strength. Accordingly, in such embodiments, the elongated post 12 is hollow between the first end portion 14 and second end portion 16. A base plate 18 is provided, having an upper surface 20, an opposite lower surface 22, and a perimeter that is larger than the periphery of the cross-sectional shape of the elongated post 12. In some embodiments, the base plate 18 is formed from aluminum, although other known materials may be used without departing from the scope of the present technology.

In various embodiments, a spacer plate 24 is provided, having an upper surface 26 and an opposite lower surface 28 that define a spacer plate thickness. The spacer plate 24 has a perimeter that is sized and shaped to approximate a size and shape of the perimeter of the base plate 18, which allows the two structures to mate with one another, seamlessly. In particular embodiments, the spacer plate 24 is provided with a thickness of approximately 0.75-inches. The spacer plate 24 includes a central aperture 30 that extends through the upper surface 26 and lower surface 28. In some embodiments, the central aperture 30 may be provided as a recess in the spacer plate 24 that extends through the upper surface 26 but not the lower surface 28. The upper surface 26 of the spacer plate 24 is positioned closely adjacent the lower surface 22 of the base plate 18. In various embodiments, the spacer plate 24 is formed from a polymer material. In particular embodiments, the spacer plate is formed from HPDE, although other known materials may be used without departing from the scope of the present technology.

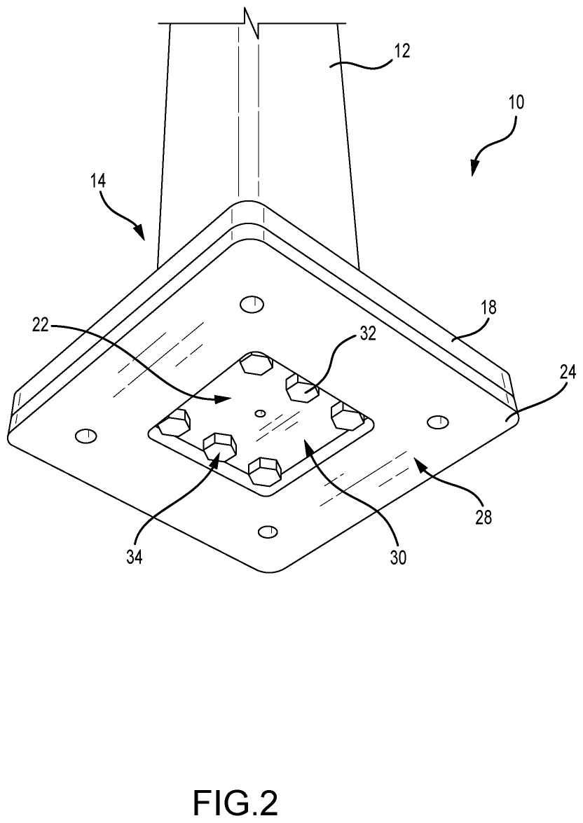

With continued reference to FIG. 1, a plurality of fasteners 32 ae provided, having head portions 34 and opposite, distal end portions 36. In various embodiments, the distal end portions 36 of the fasteners 32 are disposed through the base plate 18 and secured with the first end portion 14 of the elongated post 12 so that the head portions 34 of the fasteners are disposed within the central aperture 30 of the spacer plate 24 and positioned closely adjacent the lower surface 22 of the base plate 18, such as depicted in FIG. 2. In most embodiments, the head portions 34 of the fasteners 32 have a thickness that approximates, or is thinner than, the spacer plate 24 thickness. In particular embodiments, the spacer plate 24 is provided with a thickness of approximately 0.75-inches. In some embodiments, the plurality of fasteners 32 includes 0.5-inch diameter hex bolts with a 3-inch thread engagement with the first end portion 14 of the elongated post 12. It is contemplated that the plurality of fasteners 32 may be provided in the form of other types of bolts, screws, and other types of known mechanical fasteners. In particular embodiments, six fasteners 32 are used to secure the base plate 18 with the first end portion 14 of the elongated post 12.

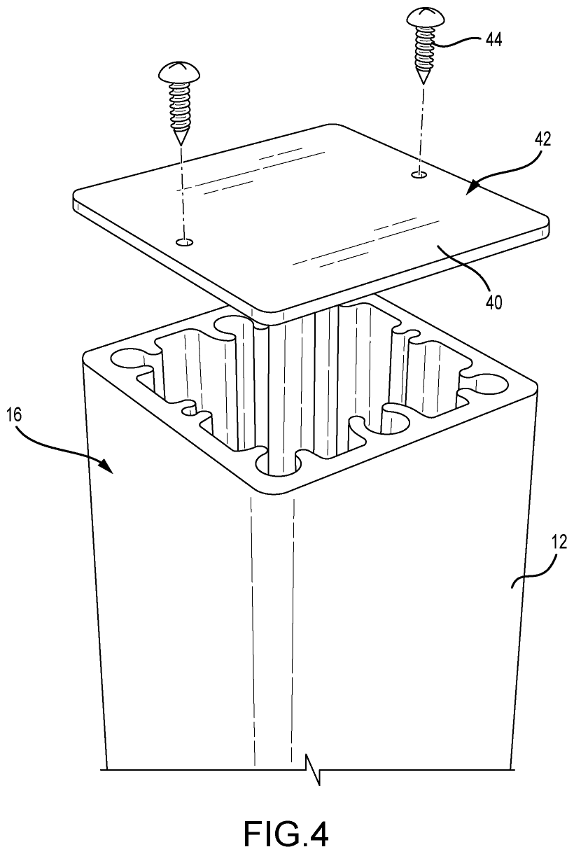

With reference to FIG. 4, a top cap 40 is provided, having a top surface 42 and an opposite lower surface (not depicted). wherein the lower surface of the top cap 40 is secured with the second end portion 16 of the elongated post 12 using a plurality of cap fasteners 44. In particular embodiments, the cap fasteners 44 are #12 thread forming screws.

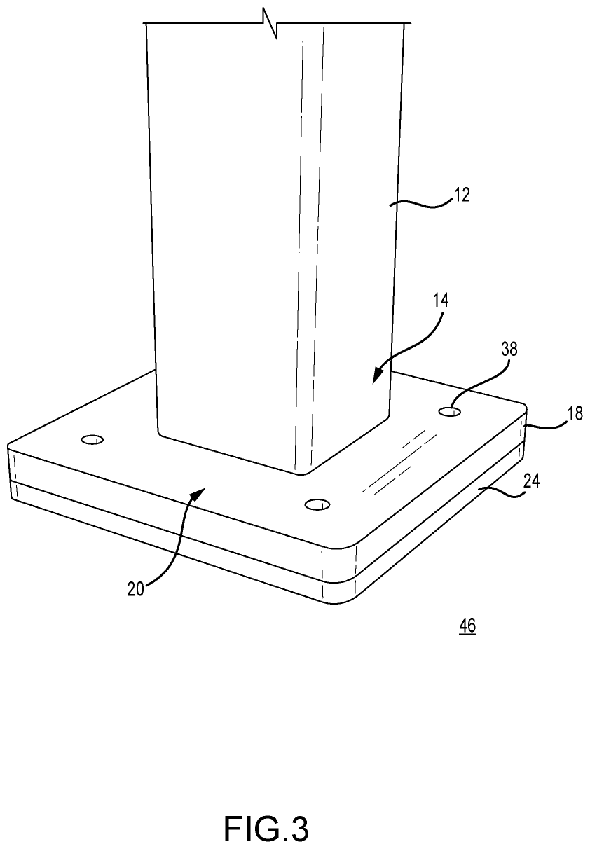

With reference to FIGS. 1-4, a method for securing a post to a mounting surface includes securing a first end portion 14 of an elongated post 12 with a base plate 18 using a plurality of fasteners 32 having head portions 34 and opposite, distal end portions 36. In some embodiments, an upper surface 26 of a spacer plate 24 is positioned closely adjacent the lower surface 22 of the base plate 18. The distal end portions 36 of the fasteners 32 are disposed through the base plate 18 and secured with the first end portion 14 of the elongated post 12, so that the head portions 34 of the fasteners 32 are disposed within the central aperture 30 of the spacer plate 24 and positioned closely adjacent the lower surface 22 of the base plate 18, as depicted in FIG. 2. The lower surface 28 of the spacer plate 24 is positioned closely adjacent the mounting surface 46. The spacer plate 24 and base plate 18 are secured with the mounting surface 46 using a plurality of mounting fasteners (not depicted). With reference to FIG. 3, mounting fasteners (not depicted) are provided that are sized to be at least partially disposed within mounting apertures 38 positioned adjacent the perimeter of the base plate 18.

Although the technology been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A system for securing a post to a mounting surface, the system comprising:
an elongated post having a first end portion, an opposite, second end portion, and a cross-sectional shape having a periphery;
a base plate having an upper surface, an opposite lower surface, and a perimeter that is larger than the periphery of the cross-sectional shape of the elongated post;
a spacer plate having an upper surface and an opposite lower surface that define a spacer plate thickness; the spacer plate includes a central aperture that extends at least through the upper surface; the upper surface of the spacer plate being positioned closely adjacent the lower surface of the base plate; and
a plurality of fasteners having head portions and opposite, distal end portions; the distal end portions of the fasteners being disposed through the base plate and secured with the first end portion of the elongated post, so that the head portions of the fasteners are disposed within the central aperture of the spacer plate and positioned closely adjacent the lower surface of the base plate.

2. The system of claim 1 wherein the spacer plate has a perimeter that is sized and shaped to approximate a size and shape of the perimeter of the base plate.

3. The system of claim 1 wherein the elongated post is hollow between the first end portion and second end portion of the elongated post; the base plate being formed from aluminum.

4. The system of claim 3 wherein the spacer plate is formed from a polymer material.

5. The system of claim 1 wherein the head portions of the fasteners have a thickness that approximates or is less than the spacer plate thickness.

6. The system of claim 5 wherein the spacer plate thickness is approximately 0.75 inches.

7. The system of claim 5 wherein the plurality of fasteners includes 0.5-inch diameter bolts.

8. The system of claim 5 wherein the plurality of fasteners includes six, 0.5-inch diameter bolts.

9. The system of claim 1 further comprising mounting fasteners that are sized to be at least partially disposed within mounting apertures positioned adjacent the perimeter of the base plate.

10. The system of claim 1 further comprising a top cap having a top surface and an opposite lower surface; wherein the lower surface of the top cap is secured with the second end portion of the elongated post using a plurality of cap fasteners.

11. A method for securing a post to a mounting surface, the method comprising:
securing a first end portion of an elongated post with a base plate using a plurality of fasteners having head portions and opposite, distal end portions; the base plate having an upper surface, an opposite lower surface, and a perimeter that is larger than a periphery of a cross-sectional shape of the elongated post;
positioning an upper surface of a spacer plate closely adjacent the lower surface of the base plate; the upper surface of the spacer plate and an opposite lower surface of the spacer plate defining a spacer plate thickness; the spacer plate including a central aperture that extends through at least the upper surface; the distal end portions of the fasteners being disposed through the baseplate and secured with the first end portion of the elongated post, so that the head portions of the fasteners are disposed within the central aperture of the spacer plate and positioned closely adjacent the lower surface of the base plate;
positioning the lower surface of the spacer plate closely adjacent the mounting surface; and
securing the spacer plate and base plate with the mounting surface using a plurality of mounting fasteners.

12. The method of claim 11 wherein the spacer plate has a perimeter that is sized and shaped to approximate a size and shape of the perimeter of the base plate.

13. The method of claim 11 wherein the elongated post is hollow between the first end portion and second end portion of the elongated post; the base plate being formed from aluminum.

14. The method of claim 13 wherein the spacer plate is formed from a polymer material.

15. The method of claim 11 wherein the head portions of the fasteners have a thickness that approximates or is less than the spacer plate thickness.

16. The method of claim 15 wherein the spacer plate thickness is approximately 0.75 inches.

17. The method of claim 15 wherein the plurality of fasteners includes 0.5-inch diameter bolts.

18. The method of claim 15 wherein the plurality of fasteners includes six, 0.5-inch diameter bolts.

19. The method of claim 11 wherein the mounting fasteners are sized to be at least partially disposed within mounting apertures positioned adjacent the perimeter of the base plate.

20. The method of claim 11 further comprising securing a lower surface of a top cap with the second end portion of the elongated post using a plurality of fasteners.
